(19) United States
(12) Patent Application Publication
(10) Pub. No.: US 2025/0370392 A1
(43) Pub. Date: Dec. 4, 2025

(54) POST-PROCESSING APPARATUS AND IMAGE FORMING SYSTEM INCORPORATING THE POST-PROCESSING APPARATUS

(71) Applicants: Kotomi KAMEYAMA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Naohiro YOSHIDA, Kanagawa (JP)

(72) Inventors: Kotomi KAMEYAMA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Naohiro YOSHIDA, Kanagawa (JP)

(21) Appl. No.: 19/208,646

(22) Filed: May 15, 2025

(30) Foreign Application Priority Data
May 31, 2024 (JP) 2024-088939

(51) Int. Cl. G03G 15/00; G03G 21/16

(52) U.S. Cl. CPC G03G 15/6544; G03G 21/1609; G03G 2215/00827

(57) ABSTRACT

A post-processing apparatus includes a manual processing device, a sheet binder, a driver, and a shield. The manual processing device has an opening to receive a sheet bundle of multiple sheets inserted into the opening. The sheet binder performs a binding operation on the sheet bundle in the manual processing device at a binding position in the opening. The driver moves the sheet binder in a first direction. The shield is movable, in a second direction intersecting the first direction, between a closed position at which the shield closes the opening and an open position at which the shield opens the opening, in response to a movement of the sheet binder in the first direction.

### CROSS-REFERENCE TO RELATED APPLICATION

This patent application is based on and claims priority pursuant to 35 U.S.C. § 119(a) to Japanese Patent Application No. 2024-088939, filed on May 31, 2024, in the Japan Patent Office, the entire disclosure of which is hereby incorporated by reference herein.

### BACKGROUND

### Technical Field

Embodiments of the present disclosure relate to a post-processing apparatus that performs a post-processing operation on a sheet, and an image forming system including the post-processing apparatus and an image forming apparatus.

### Related Art

Various types of post-processing apparatuses are known that perform a sheet binding operation (post-processing operation) on a sheet bundle manually inserted to a sheet bundle inserter in an image forming system (image forming apparatus).

Specifically, some post-processing apparatuses in the art are disposed in an exterior of an image forming apparatus and perform a sheet binding operation on the corner of a sheet bundle that is manually inserted to a slit (opening portion) by a user.

On the other hand, a post-processing apparatus in the art is disclosed to have a technique of operating a shielding member that is driven by a motor to open and close a slit in order to prevent a failure in which a mechanical sound of an interior of the post-processing apparatus from leaking to the exterior from a slit (opening portion) formed in a manual binding unit.

### SUMMARY

Embodiments of the present disclosure described herein provide a novel post-processing apparatus including a manual processing device, a sheet binder, a driver, and a shield. The manual processing device has an opening to receive a sheet bundle of multiple sheets inserted into the opening. The sheet binder performs a binding operation on the sheet bundle in the manual processing device at a binding position in the opening. The driver moves the sheet binder in a first direction. The shield is movable, in a second direction intersecting the first direction, between a closed position at which the shield closes the opening and an open position at which the shield opens the opening, in response to a movement of the sheet binder in the first direction.

Further, embodiments of the present disclosure described herein provide an image forming system including an image forming apparatus to form an image on a sheet of a sheet bundle, and the above-described post-processing apparatus to perform the binding operation on the sheet bundle inserted in the manual processing device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to an embodiment of the present disclosure;

FIG. 2 is a block diagram illustrating an automatic processing device of a post-processing apparatus in the image forming system of FIG. 1;

FIG. 3 is a top view of a post-processing apparatus;

FIGS. 4A, 4B, 4C and 4D are diagrams illustrating a manual processing device in a post-processing apparatus;

FIG. 5 is a diagram illustrating a manual processing device according to another embodiment;

FIGS. 6A, 6B and 6C are diagrams illustrating operations of a shielding member and a sheet binder in a manual processing device;

FIGS. 7A, 7B and 7C are diagrams illustrating subsequent operations of the shielding member and the sheet binder of FIGS. 6A, 6B and 6C;

FIG. 8 is a flowchart of an example of control in a manual binding operation;

FIG. 9 is a block diagram illustrating a control system of an image forming system;

FIGS. 10A and 10B are diagrams illustrating a manual processing device in a post-processing apparatus according to Modification 1;

FIG. 11 is a flowchart of control in a manual binding operation performed by a post-processing apparatus of FIGS. 10A and 10B;

FIG. 12 is a top view of a post-processing apparatus according to Modification 2;

FIGS. 13A, 13B and 13C are diagrams illustrating operations of a shielding member and a sheet binder in a manual processing device of a post-processing apparatus; and

FIG. 14 is a diagram illustrating an overall configuration of an image forming system according to Modification 3.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to the drawings. Like reference signs are assigned to identical or equivalent components and a description of those components may be simplified or omitted.

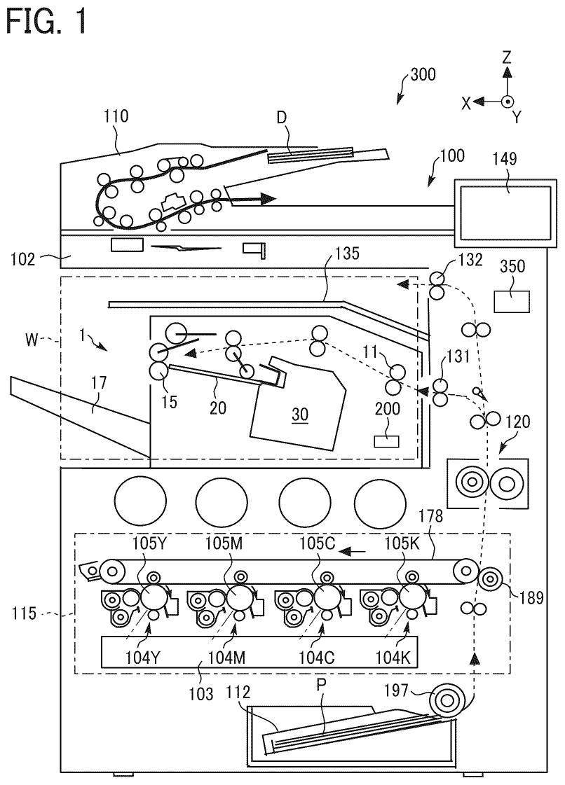

A description is now given of the configuration and functions of an image forming system 300 according to an embodiment of the present disclosure, with reference to FIG. 1.

FIG. 1 is a diagram illustrating an overall configuration of an image forming system according to an embodiment of the present disclosure.

As illustrated in FIG. 1, the image forming system 300 according to the present embodiment includes a post-processing apparatus 1 (sheet processing apparatus) including a function of a binding process. The post-processing apparatus 1 is detachably attached to an in-body space W of an image forming apparatus 100. The in-body space W is a space between a document reading device 102 and an image forming device 115. The in-body space W is a space to which a sheet P (sheet subjected to a print job) ejected from the image forming apparatus 100 can be ejected. The in-body space W is also a space from which the sheet P ejected from the image forming apparatus 100 can be removed (taken out). In other words, when the post-processing apparatus 1 is not installed to the image forming system 300, the in-body space W functions as a space (ejection part) in which the sheet P is or multiple sheets P ejected from the image forming apparatus 100 are stacked.

The image forming apparatus 100 is the part of the image forming system 300 other than the post-processing apparatus 1. In other words, the image forming system 300 includes the image forming apparatus 100 and the post-processing apparatus 1. The image forming apparatus 100 includes the image forming device 115, an apparatus sheet tray 112, a fixing device 120, a document feeder 110, and the document reading device 102. The image forming apparatus 100 (image forming system 300) has an exterior to which the operation display panel 149 (operation display) that displays various kinds of information and inputs various kinds of commands for the image forming system 300.

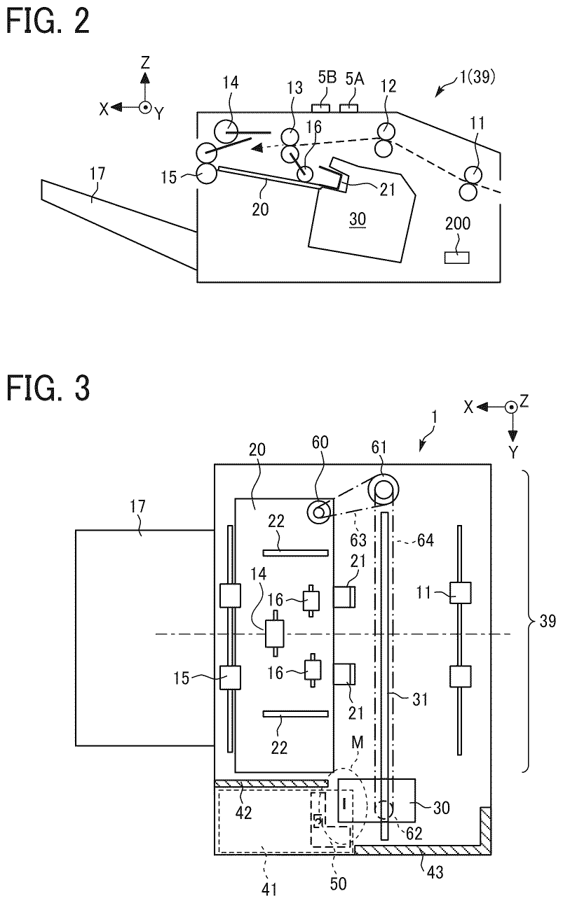

FIG. 2 is a block diagram illustrating an automatic processing device of a post-processing apparatus in the image forming system 300 of FIG. 1.

FIG. 3 is a top view of a post-processing apparatus.

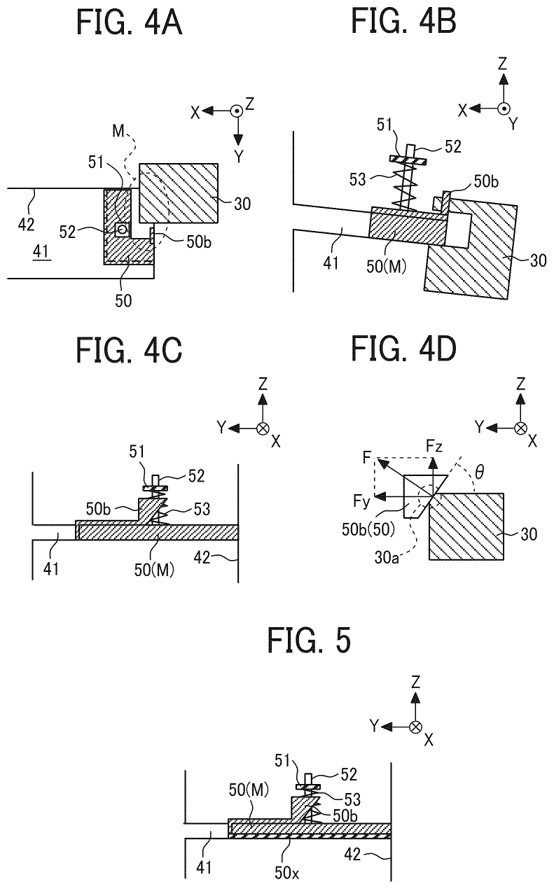

FIGS. 4A, 4B, 4C and 4D are diagrams illustrating a manual processing device in a post-processing apparatus.

Referring to FIGS. 1 to 4D, the post-processing apparatus 1 includes a sheet binder 30, an internal tray 20, an ejection roller pair 15, an ejection tray 17, and multiple conveyance roller pairs 11, 12 and 13.

The post-processing apparatus 1 is disposed downstream from the image forming apparatus 100 in the sheet conveyance direction (a direction in which the sheet P is conveyed). The post-processing apparatus 1 is an apparatus for performing a sheet binding operation (staple binding operation) on multiple sheets P that is ejected from the image forming apparatus 100 after a print job has been performed, and performing a sheet binding operation (staple binding operation) on a sheet bundle PT set manually, which will be described in detail below.

A description below is given of the image forming operation (printing operation) in the image forming apparatus 100 of the image forming system 300, with reference to FIG. 1.

In the image forming apparatus 100 with reference to FIG. 1, multiple pairs of sheet conveying rollers disposed in the document feeder 110 feed an original document D from a document loading table and convey the original document D in a direction indicated by arrow in FIG. 1. By so doing, the original document D passes over the document reading device 102. At this time, the document reading device 102 optically reads image data of the original document D while the original document D is passing over the document reading device 102.

The image data optically scanned by the document reading device 102 is converted into electrical signals. The electrical signals are then transmitted to a writing device 103. The writing device 103 emits laser beams onto the photoconductor drums 105Y, 105M, 105C, and 105K based on the electrical signals of the image data in each of colors, respectively, performing an exposing process.

In the image forming apparatus 100, a charging process, the exposing process, and a developing process are sequentially executed on the photoconductor drums 105Y, 105M, 105C, and 105K of respective image forming units 104Y, 104M, 104C, and 104K to form desired images on the photoconductor drums 105Y, 105M, 105C, and 105K, respectively.

The images formed on the photoconductor drums 105Y, 105M, 105C, and 105K are transferred and superimposed onto the intermediate transfer belt 178 to form a color image. The color image formed on the intermediate transfer belt 178 is transferred onto the surface of the sheet P fed and conveyed by a sheet feed roller 197 from the apparatus sheet tray 112 (second sheet feeder) at a position at which the intermediate transfer belt 178 faces a secondary transfer roller 189.

After the color image is transferred onto the surface of the sheet P, the sheet P is conveyed to the position of the fixing device 120. The fixing device 120 fixes the transferred color image formed on the surface of the sheet P, to the sheet P.

Subsequently, based on the user's selection of the printing mode, the sheet P is ejected from the image forming apparatus 100 by a first ejection roller pair 131 to be conveyed to the post-processing apparatus 1 or is ejected from the image forming apparatus 100 by a second ejection roller pair 132 to be stacked on an ejection tray 135.

In the present embodiment, the post-processing apparatus 1 is coupled (installed) to the in-body space W of the image forming apparatus 100, and the sheet P ejected from the image forming apparatus 1 is conveyed to the post-processing apparatus 1 based on the user's selection, and the post-processing apparatus 1 performs a post-processing operation on the sheet P conveyed from the image forming apparatus 100.

By installing the post-processing apparatus 1 in the in-body space W of the image forming apparatus 100, the in-body space W is effectively used, and the image forming system 300 can be downsized.

Referring to FIG. 2, the post-processing apparatus 1 (automatic processing device 39) in the present embodiment conveys a sheet P conveyed from the image forming apparatus 100 to a conveyance path in which a post-processing operation, such as a sheet binding operation, is performed on the sheet P or the sheet P is ejected without the sheet binding operation. The conveyance path is a conveyance path indicated by a broken line in FIG. 2 and is defined by three conveyance roller pairs, which are a first conveyance roller pair 11, a second conveyance roller pair 12, and a third conveyance roller pair 13.

Specifically, when a mode in which the post-processing operation is not performed on a sheet or sheets is selected, the sheet P conveyed by the first conveyance roller pair 11, the second conveyance roller pair 12, and the third conveyance roller pair 13 is ejected by the ejection roller pair 15 to be placed on the ejection tray 17.

When a “sorting mode (sorting processing mode)” is selected, the sheet P is conveyed while being shifted in the width direction of the sheet P by a given amount for each sheet P by the third conveyance roller pair 13 that is movable in the width direction (that is a direction orthogonal to the drawing sheet of FIG. 2), and multiple sheets P are sequentially stacked on the ejection tray 17.

When the “binding mode (stapling mode)” is selected, the sheets P conveyed by the first conveyance roller pair 11, the second conveyance roller pair 12, and the third conveyance roller pair 13 are sequentially stacked on the internal tray 20 without being ejected by the ejection roller pair 15. At this time, each time a sheet P is placed on the internal tray 20, a tapping roller 14 and a return roller 16 both disposed above the internal tray 20 move from the standby position to a position where the tapping roller 14 and the return roller 16 contact the sheet P (the uppermost sheet P of the sheet bundle PT), and the tapping roller 14 and the return roller 16 are driven and rotated in the counterclockwise direction in FIG. 2. By so doing, the sheet P is conveyed (moved) toward an end fence 21. Thus, the trailing end (the trailing end in the sheet conveyance direction) of the multiple sheets P (the sheet bundle PT) contacts the end fence 21, and the positions of the multiple sheets P (sheet bundle PT) in the sheet conveyance direction are aligned.

At this time, referring to FIG. 3, each time a sheet P is placed on the internal tray 20 (or after a desired number of sheets P are placed on the internal tray 20), jogger fences 22 (side fences) disposed at both ends of the internal tray 20 in the width direction move in the width direction to sandwich the sheet P (sheet bundle PT). By so doing, the position of the sheet P (the sheet bundle PT) in the width direction is aligned. Then, a sheet binding operation is performed on the trailing end of the sheets P (sheet bundle PT) aligned in the sheet conveyance direction and the width direction by the sheet binder 30.

Thereafter, the sheets P (sheet bundle PT) subjected to the sheet binding process are moved obliquely upward along the tray surface of the internal tray 20 by the reverse rotation (the rotation in the clockwise direction in FIG. 2) of the return roller 16, and are ejected onto the ejection tray 17 by the ejection roller pair 15.

In the present embodiment, the sheet binder 30 is movable in the width direction (a direction orthogonal to the drawing sheet of FIG. 2 and a vertical direction in FIG. 3) along a guide rail 31 extending in the width direction by a movement mechanism including the following components (with reference numerals 60 to 64).

More specifically, the movement mechanism (moving device) includes a stapler drive motor 60, a first timing belt 63, and a second timing belt 64. The first timing belt 63 is wound taut around a pulley mounted on the motor shaft of the stapler drive motor 60 and a first pulley 61. The second timing belt 64 is wound taut around the first pulley 61 and a second pulley 62 mounted on the sheet binder 30. As the stapler drive motor 60 is driven to rotate in the forward and reverse directions, the sheet binder 30 is moved in the width direction (±Y direction).

With this configuration, the sheet binding operation can be performed on the sheet bundle PT placed on the internal tray 20, at a desired position in the width direction of the sheet bundle PT.

In particular, the sheet binder 30 is movable to the position of a manual processing device 41, which is described below. Due to such a configuration, the sheet binding operation can be performed in the manual processing device 41.

The post-processing apparatus 1 according to the present embodiment includes the sheet binder 30 that performs the sheet binding operation (staple binding operation) using staples (metallic needles) on the sheet bundle PT. However, the sheet binder 30 is not limited to have the above-described configuration. For example, the post-processing apparatus 1 may include a sheet binder that performs a sheet binding operation on a sheet bundle PT without using staples (metallic needles).

A detailed description is given below of the configuration and operations of the post-processing apparatus 1 according to the present embodiment.

In the present embodiment, as illustrated in FIG. 4B, the manual processing device 41 has a sheet stacker (bottom face) on which the sheet P is inserted and placed. The sheet stacker is inclined downward from the front side in the insertion direction (+X direction) toward the back side (−X direction). However, the illustration of the inclination is omitted appropriately in the other drawings. In addition, when the direction is described using the reference signs X, Y and Z according to such an illustration, such a slight inclination is ignored.

As described above with reference to FIGS. 1 to 3, the post-processing apparatus 1 according to the present embodiment includes the automatic processing device 39 that performs the sheet binding operation on a sheet bundle PT that is prepared by overlapping multiple sheets P that are ejected from the image forming apparatus 100 and conveyed to the post-processing apparatus 1.

The post-processing apparatus 1 according to the present embodiment includes, in addition to the automatic processing device 39 described above, the manual processing device 41 to perform a sheet binding operation on a sheet bundle PT that is manually set (manually inserted) by a user. In other words, the manual processing device 41 is a part to which the sheet bundle PT of multiple sheets P is inserted.

Specifically, the manual processing device 41 is a device included in the post-processing apparatus 1 disposed in the in-body space W of the image forming system 300 and where the user inserts the sheet bundle PT from the front side (the side facing the operation display panel 149) in the post-processing apparatus 1, so as to perform the sheet binding operation on the corner of the sheet bundle PT.

Due to such a configuration, the sheet binder 30 preforms the sheet binding operation on the sheet bundle PT inserted in the manual processing device 41 at the leading end on the downstream side in the manual insertion direction. In particular, the manual processing device 41 according to the present embodiment is a slit (see FIG. 4B).

Further, the post-processing apparatus 1 has a first guide wall 42 that separates the manual processing device 41 in the −Y direction from the interior of the post-processing apparatus 1. In addition, the post-processing apparatus 1 has a second guide wall 43 that separates the manual processing device 41 in the-X direction from the interior of the post-processing apparatus 1.

Referring to FIGS. 3 and 4D, the manual processing device 41 communicates with the interior of the post-processing apparatus 1 through an opening M. In other words, when viewed from the manual processing device 41, the opening M of the post-processing apparatus 1 is a hole communicating with the inside and the outside of the post-processing apparatus 1.

FIG. 5 is a diagram illustrating a manual processing device according to another embodiment.

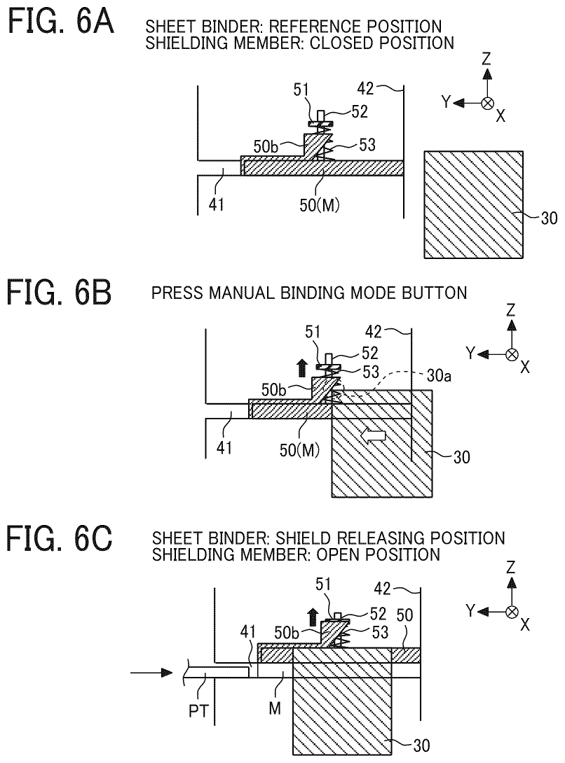

FIGS. 6A, 6B and 6C are diagrams illustrating operations of a shielding member and a sheet binder in a manual processing device.

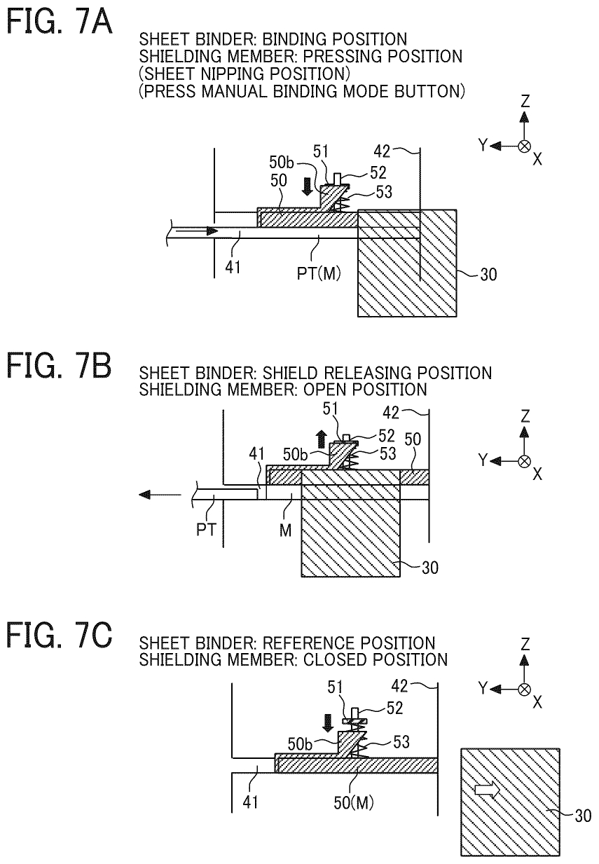

FIGS. 7A, 7B and 7C are diagrams illustrating subsequent operations of the shielding member and the sheet binder 30 of FIGS. 6A, 6B and 6C.

The sheet binder 30 preforms the sheet binding operation on the sheet bundle PT inserted in the manual processing device 41 at the binding position (the position illustrated, for example, in FIGS. 3 and 7A) of the opening M. Specifically, the sheet binder 30 stands by at a reference position (home position) illustrated in FIG. 6A before a job (before the start of the sheet binding operation) in both cases where the sheet binding operation is performed by the automatic processing device 39 and where the manual binding operation is performed by the manual processing device 41. Then, in the manual binding operation, the sheet binder 30 moves from the reference position to the binding position of the opening M to perform the sheet binding operation on the sheet bundle PT inserted in the manual processing device 41 with a part being exposed through the opening M to the manual processing device 41.

Referring to FIGS. 6A through 6C, the post-processing apparatus 1 according to the present embodiment includes a shielding member 50 as a shield that is an opening-and-closing member that moves from a closed position at which the opening M is closed (the position illustrated in FIGS. 4A, 4B, 4C, 4D and 6A) to an open position at which the closed state of the opening M is cancelled (the illustrated in FIG. 6C) along with an operation in which the sheet binder 30 moves from the reference position illustrated in FIG. 6A to a shield releasing position (the position illustrated in FIG. 6C) (in other words, an operation in which the sheet binder 30 moves movement in the +Y direction).

Accordingly, the movement mechanism (i.e., the stapler drive motor 60, the first pulley 61, the first timing belt 63, and the second timing belt 64) described above with reference to FIG. 3 functions as a moving device that moves from a position different from the shield releasing position to the shield releasing position. Specifically, each of the movement mechanism (i.e., the stapler drive motor 60, the first pulley 61, the first timing belt 63, and the second timing belt 64) functions as a moving device that moves the sheet binder 30 to any one of the reference position, the binding position, and the shield releasing position.

The shielding member 50 moves downward from the open position illustrated in FIG. 6C to the closed position along with the operation in which the movement mechanism (i.e., the stapler drive motor 60, the first pulley 61, the first timing belt 63, and the second timing belt 64) (moving device) causes the sheet binder 30 to move from the shield releasing position illustrated in FIG. 6C to a position other than the shield releasing position (in other words, the binding position illustrated in FIG. 7A or the reference position illustrated in FIG. 7C).

In particular, in the present embodiment, the shielding member 50 moves from the open position illustrated in FIG. 6C to the position where the sheet bundle PT that is manually inserted and placed to the manual processing device 41 is nipped (the position illustrated in FIG. 7A that is the pressing position), along with the operation in which the movement mechanism (i.e., the stapler drive motor 60, the first pulley 61, the first timing belt 63, and the second timing belt 64) (moving device) causes the sheet binder 30 to move from the shield releasing position illustrated in FIG. 6C to the binding position illustrated in FIG. 7A.

Due to such a configuration, when the sheet binder 30 performs the sheet binding operation (the manual binding operation) on the sheet bundle PT, the sheet bundle PT placed on the sheet stacker of the manual processing device 41 is pressed downward by the shielding member 50 to be stable (less displaceable), and a preferable sheet binding operation can be performed.

In the present embodiment, the bottom face of the shielding member 50 (the face facing the sheet stacker of the manual processing device 41) is a flat face.

Then, as illustrated in FIG. 5, an elastic member 50x made of, for example, a rubber material may be disposed on the bottom face of the shielding member 50. In this case, even if the sheet bundle PT is pressed by the shielding member 50, the sheet bundle PT is less likely to be damaged.

As described above, the post-processing apparatus 1 according to the present embodiment includes the shielding member 50 that opens and closes the opening M. When the automatic processing device 39 causes the sheet binder 30 to perform the automatic sheet binding operation, the opening M is closed by the shielding member 50. For this reason, the failure in which a mechanical sound generated in the interior of the post-processing apparatus 1 or a sound such as a sheet conveyance sound leaks from the opening M to the outside of the sheet binder 30 can be reduced. Further, when the manual processing device 41 causes the sheet binder 30 to perform the manual binding operation (manual binding operation), the shielding member 50 cancels the closure of the opening M to open the opening M. For this reason, the manual binding operation performed by the sheet binder 30 can be performed at the binding position of the opening M (manual binding position).

Moreover, the opening and closing of the opening M by the shielding member 50 is not performed by driving a dedicated motor (a dedicated motor for opening and closing the opening M is not installed), but is performed along with the movement of the sheet binder 30 by the movement mechanism (i.e., the stapler drive motor 60, the first pulley 61, the first timing belt 63, and the second timing belt 64). As a result, when compared with a configuration including a dedicated motor, the post-processing apparatus 1 is less likely to increase in size and cost.

A detailed description is given below of an opening and closing mechanism of the shielding member 50.

Referring to FIGS. 4A to 7C, the post-processing apparatus 1 includes a guide 51 and a compression spring 53. The guide 51 guides the shielding member 50 to be movable in the vertical direction between the closed position illustrated in, for example, FIG. 6A and the open position illustrated in, for example, FIG. 6C. The compression spring 53 as a biasing member to bias the shielding member 50 downward toward the closed position.

Specifically, the guide 51 is fixed to the housing of the post-processing apparatus 1 and has a through hole through which a shaft 52 is passed. The shaft 52 stands upward from the ceiling of the shielding member 50. The compression spring 53 as a biasing member is wound around the shaft 52 between the guide 51 and the ceiling of the shielding member 50. Due to such a configuration as described above, the shielding member 50 is biased downward (in a direction to close the opening M) by the compression spring 53 between the shielding member 50 and the guide 51.

Along with the operation in which the sheet binder 30 moves to the shield releasing position illustrated in FIG. 6C, the shielding member 50 is pressed and moved by a moving part 30a of the sheet binder 30 (the shielding member 50 contacts the moving part 30a of the sheet binder 30) and moves upward toward the open position illustrated in FIG. 6C so that the shielding member 50 moves against the biasing force of the compression spring 53 (biasing member).

As illustrated in FIGS. 4A, 4B, 4C, 4D and 5, the shielding member 50 has a tapered portion 50b (inclined portion) in a portion that contacts the moving part 30a of the sheet binder 30. Accordingly, as illustrated in the diagram of FIG. 4D, when the movement mechanism (i.e., the stapler drive motor 60, the first pulley 61, the first timing belt 63, and the second timing belt 64) is driven to move the sheet binder 30 in the +Y direction with the moving part 30a of the sheet binder 30 contacting the tapered portion 50b, the component force Fz is applied in the +Z direction to restrict the movement of the shielding member 50 by the guide 51 in a direction other than the Z direction, and the shielding member 50 moves upward. The component force Fz in the +Z direction can be adjusted by varying the inclination angle θ of the tapered portion 50b.

In the present embodiment, the tapered portion 50b is formed on the shielding member 50. However, the structure of the shielding member 50 is not limited to the above-described structure. For example, a tapered portion that applies the above-described component force in the +Z direction may be formed in the moving part 30a of the sheet binder 30 or a tapered portion may be formed in both the shielding member 50 and the sheet binder 30.

Further, referring to FIGS. 7A and 7B, in the present embodiment, a controller 200 controls the movement mechanism (i.e., the stapler drive motor 60, the first pulley 61, the first timing belt 63, and the second timing belt 64) (moving device) to move the sheet binder 30 from the binding position to the shield releasing position illustrated in FIG. 7B after the sheet binder 30 has finished the sheet binding operation (manual binding operation) on the sheet bundle PT at the binding position (the position illustrated in FIG. 7A).

In other words, the shielding member 50 moves upward toward the open position from the pressing position after the sheet binding operation.

By performing such control, the sheet bundle PT after the sheet binding operation is released from the nipping (pressing) by the shielding member 50, and the sheet bundle PT can be taken out from the manual processing device 41 by the user without much resistance.

In the present embodiment, when the sheet binder 30 is located at the shield releasing position illustrated in FIGS. 6C and 7B, the controller 200 controls the sheet binder 30 to perform the sheet binding operation on the sheet bundle PT as the manual binding operation start button 5B (see FIG. 2) as a start button is pressed.

Then, in a case where the manual binding operation start button is not pressed even after a given time T (min.) has passed from when the previous sheet binding operation has been performed or after the shielding member 50 is moved from the closed position to the open position, the movement mechanism (i.e., the stapler drive motor 60, the first pulley 61, the first timing belt 63, and the second timing belt 64) (moving device) causes the sheet binder 30 to move from the binding position illustrated in FIG. 7A to the reference position inside the post-processing apparatus 1 (the position illustrated in FIGS. 6A and 7C).

By performing such control, even when the manual binding operation is interrupted regardless of whether the user is aware of the interruption of the manual binding operation, the failure in which the shielding member 50 is left at the open position can be avoided.

A description is given below of a series of operations of the shielding member 50 and the sheet binder 30 with respect to the manual processing device 41 as described above, with reference to FIGS. 6A, 6B, 6C, 7A, 7B and 7C.

First, as described above, the sheet binder 30 is located at the reference position (home position) illustrated in FIG. 6A in the interior of the post-processing apparatus 1 before the job. At this time, the shielding member 50 is located at the closed position where the opening M is shielded (closed).

Then, as illustrated in FIG. 6B, when the manual binding operation mode button 5A (see FIG. 2) is pressed by the user, the sheet binder 30 starts to move from the reference position in the +Y direction by the control of the movement mechanism (the stapler drive motor 60) by the controller 200. Then, the moving part 30a of the sheet binder 30 comes into contact with the tapered portion 50b of the shielding member 50.

Then, as illustrated in FIG. 6C, when the sheet binder 30 is further moved in the +Y direction and reaches the shielding release position, the shielding member 50 completely reaches the open position by pushing up (the moving part 30a of) the sheet binder 30, and the user can insert the sheet bundle PT into the manual processing device 41. It is preferable that such a state is notified to the user by, for example, the operation display panel 149 or a sound.

Subsequently, as illustrated in FIG. 7A, when the sheet bundle PT is inserted into the opening M of the manual processing device 41 by the user and the manual binding operation start button 5B is pressed, the controller 200 controls the movement mechanism (the stapler drive motor 60) to move the sheet binder 30 from the shield releasing position in the-Y direction to reach the binding position. At this time, the shielding member 50 is lowered to the pressing position where the sheet bundle PT is nipped in the manual processing device 41 by the biasing force of the compression spring 53 and the weight of the shielding member 50. The controller 200 controls the sheet binder 30 with the shielding member 50 being lowered, so that the sheet binder 30 performs the sheet binding operation on the sheet bundle PT.

Then, as illustrated in FIG. 7B, when the sheet binding operation is finished, the controller 200 controls the movement mechanism (the stapler drive motor 60) to cause the sheet binder 30 to move from the pressing position in the +Y direction to reach the shield releasing position. As a result, the pressing by the shielding member 50 is released, and the sheet bundle PT (sheet bundle subjected to the sheet binding operation) can be preferably taken out from the manual processing device 41.

Eventually, the controller 200 controls the movement mechanism (the stapler drive motor 60) to move the sheet binder 30 from the shield releasing position in the −Y direction to return to the reference position, so as to complete the series of the manual binding operation. At this time, the shielding member 50 is located at the closed position where the opening M is shielded (closed).

The states in which the above-described sheet binder 30 is located at the reference position, the shield releasing position, or the pressing position are detected by position detectors such as photosensors located respective positions.

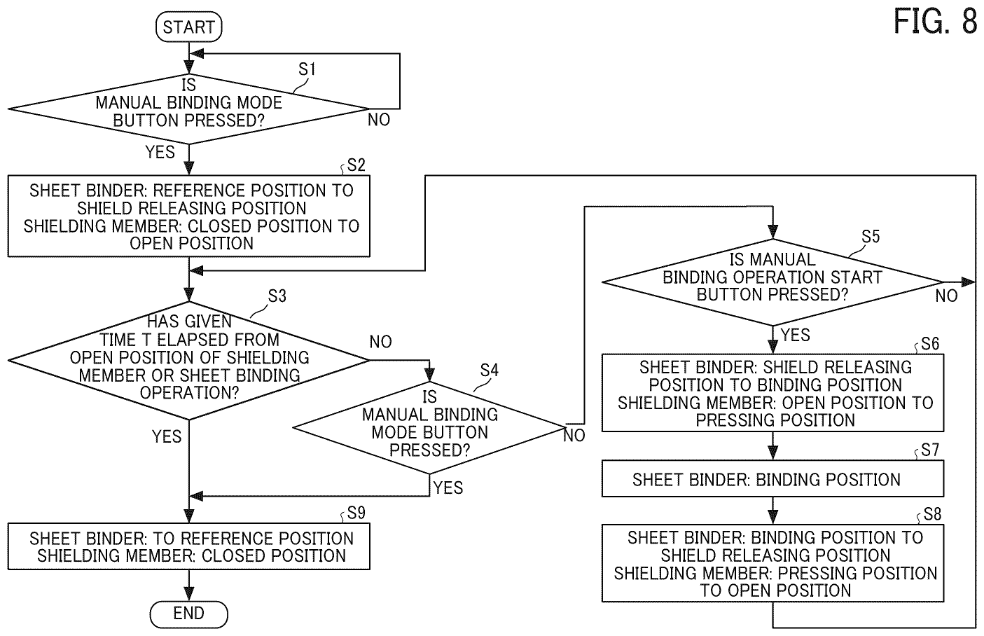

A description is given below of an example of a control flow in the manual binding operation, with reference to FIG. 8.

FIG. 8 is a flowchart of an example of control in a manual binding operation.

As illustrated in FIG. 8, in step S1, it is determined that the manual binding operation mode button 5A (see FIG. 2) is pressed. When the manual binding operation mode button 5A is not pressed (NO in step S1), step S1 is repeated until the manual binding operation mode button 5A is pressed. On the other hand, when the manual binding operation mode button 5A is pressed (YES in step S1), the movement mechanism (i.e., the stapler drive motor 60, the first pulley 61, the first timing belt 63, and the second timing belt 64) causes the sheet binder 30 to move from the reference position to the shield releasing position, and the shielding member 50 moves upward from the closed position to the open position along with the movement of the sheet binder 30 (step S2).

Then, it is determined whether the given time T has elapsed since the shielding member 50 has moved to the open position or since the previous manual binding operation has been performed (step S3). As a result, when the given time T has not elapsed, it is determined whether the manual binding operation mode button 5A (see FIG. 2) is pressed (step S4). When the manual binding operation mode button 5A is not pressed (NO in step S4), it is further determined whether the manual binding operation start button 5B (see FIG. 2) is pressed (step S5).

As a result, when the manual binding operation start button 5B is pressed (YES in step S5), the movement mechanism (i.e., the stapler drive motor 60, the first pulley 61, the first timing belt 63, and the second timing belt 64) causes the sheet binder 30 to move from the shield releasing position to the binding position, and the shielding member 50 is moved downward from the open position to the pressing position to fix the sheet bundle PT along with the movement of the sheet binder 30 (step S6). In this state, the sheet binder 30 performs the sheet binding operation (step S7). Subsequently, the movement mechanism (i.e., the stapler drive motor 60, the first pulley 61, the first timing belt 63, and the second timing belt 64) causes the sheet binder 30 to move the binding position to the shield releasing position, the shielding member 50 moves upward from the pressing position to the open position to release the fixing of the sheet bundle PT along with the movement of the sheet binder 30 (step S8). Then, the flow from step S3 is performed.

Further, when the given time T has elapsed in step S3 or when the manual binding operation mode button 5A is pressed in step S4, the movement mechanism (i.e., the stapler drive motor 60, the first pulley 61, the first timing belt 63, and the second timing belt 64) causes the sheet binder 30 to move to the reference position, the shielding member 50 moves downward to the closed position along with the movement of the sheet binder 30 (step S9). Then, the flow is ended.

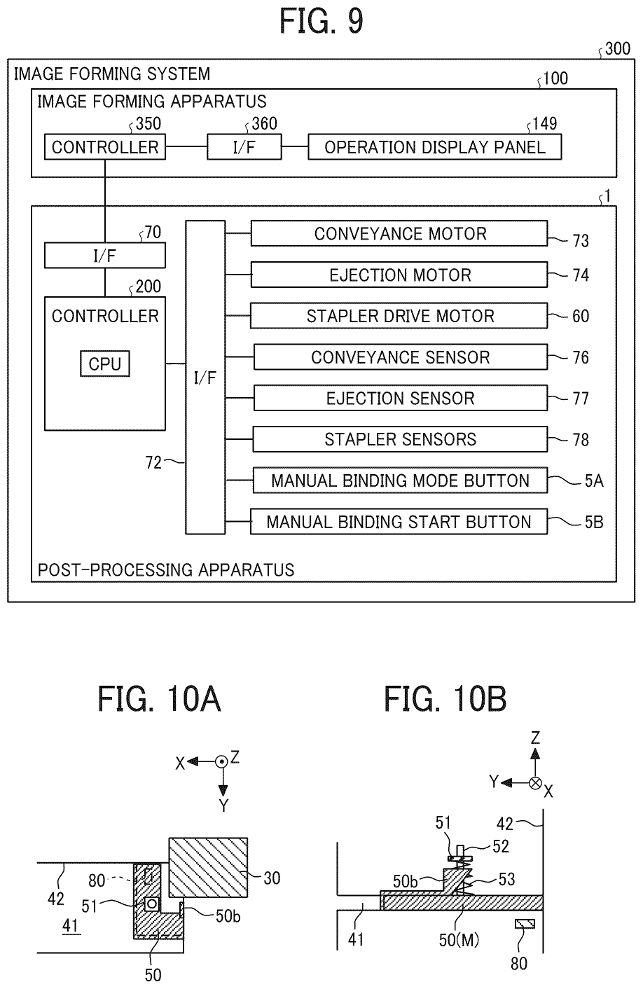

FIG. 9 is a block diagram illustrating a control system of an image forming system.

The post-processing apparatus 1 having the configuration described above is controlled by the controller 200 illustrated in FIG. 9 (and FIG. 1).

As illustrated in FIG. 9, the controller 200 of the post-processing apparatus 1 is connected to a controller 350 of the image forming apparatus 100 via an interface 70. The controller 350 of the image forming apparatus 100 is connected, via the interface 360, to the operation display panel 149 and various drive members and sensors of the image forming apparatus 100. The controller 200 of the post-processing apparatus 1 is connected, via an interface 72, to, for example, a conveyance motor 73 that drives and rotates the first conveyance roller pair 11, the second conveyance roller pair 12, the third conveyance roller pair 13, the tapping roller 14, and the return roller 16; an ejection motor 74 that drives and rotates the ejection roller pair 15; the stapler drive motor 60 that drives the sheet binder 30; a conveyance sensor 76 disposed on the conveyance path; an ejection sensor 77 disposed at an ejection port, stapler sensors 78 each of which detects the reference position, the shield releasing position and the pressing position of the sheet binder 30; a manual binding operation mode button 5A; and a manual binding operation start button 5B.

The overall control system of the image forming system 300 having the configuration described above executes various operations in the image forming system 300 described above.

### Modification 1

FIGS. 10A and 10B are diagrams illustrating a manual processing device in a post-processing apparatus according to Modification 1.

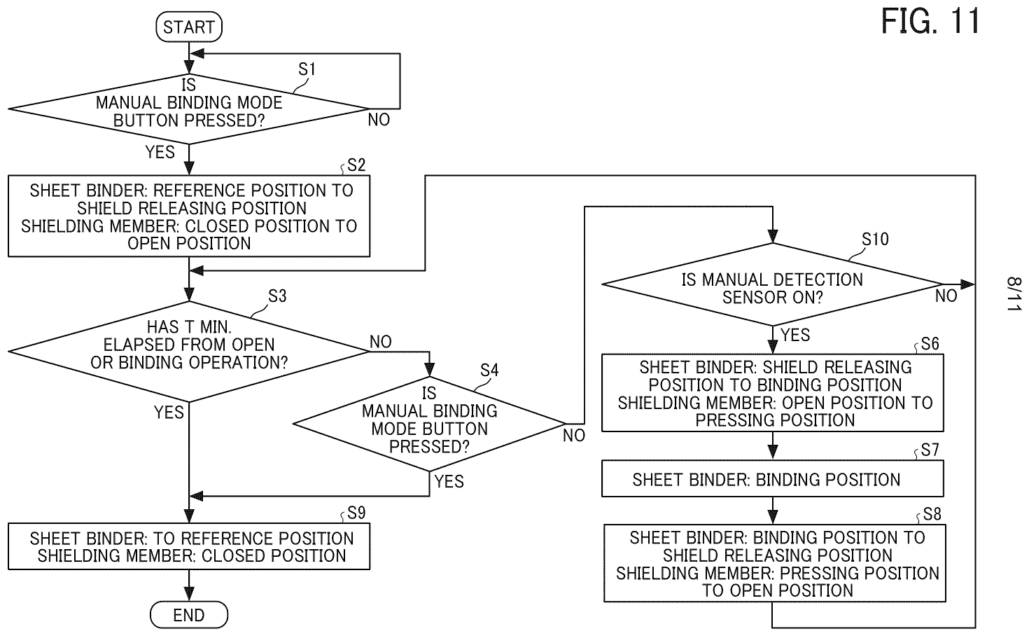

FIG. 11 is a flowchart of control in a manual binding operation performed by a post-processing apparatus of FIGS. 10A and 10B.

As illustrated in FIGS. 10A and 10B, the post-processing apparatus 1 according to Modification 1 includes a manual detection sensor 80 (for example, a reflection type photosensor) as a detector at the binding position of the opening M in the manual processing device 41. The manual detection sensor 80 optically detects whether the sheet bundle PT is at the binding position.

Then, when the sheet binder 30 is located at the shield releasing position (the position illustrated in FIG. 6C), the manual detection sensor 80 (detector) detects that the sheet bundle PT is inserted to the binding position. Thus, the controller 200 controls the sheet binder 30 to perform the sheet binding operation on the sheet bundle PT. In other words, after the manual detection sensor 80 detects the sheet bundle PT that is an object on which the sheet binding operation is performed, the controller 200 controls the sheet binder 30 to perform the sheet binding operation on the sheet bundle PT.

Then, in a case where the sheet bundle PT is not detected by the manual detection sensor 80 (detector) even after a given time T (min.) has passed from when the previous sheet binding operation has been performed or after the shielding member 50 is moved from the closed position to the open position, the controller 200 controls the movement mechanism (i.e., the stapler drive motor 60, the first pulley 61, the first timing belt 63, and the second timing belt 64) (moving device) to move the sheet binder 30 from the binding position illustrated in FIG. 7A to the reference position inside the post-processing apparatus 1 (the position illustrated in FIGS. 6A and 7C).

By performing such control, even when the manual binding operation is interrupted regardless of whether the user is aware of the interruption of the manual binding operation, the failure in which the shielding member 50 is left at the open position can be avoided. In other words, referring to the control flow illustrated in FIG. 11, step S10 of determining whether the manual detection sensor 80 detects the sheet bundle PT (whether the manual detection sensor 80 is turned on) is performed instead of step S5 of the control flow illustrated in FIG. 8.

Also in the post-processing apparatus 1 according to Modification 1, the post-processing apparatus 1 can reduce sound leakage from the opening M of the manual processing device 41 without increasing in size and cost.

### Modification 2

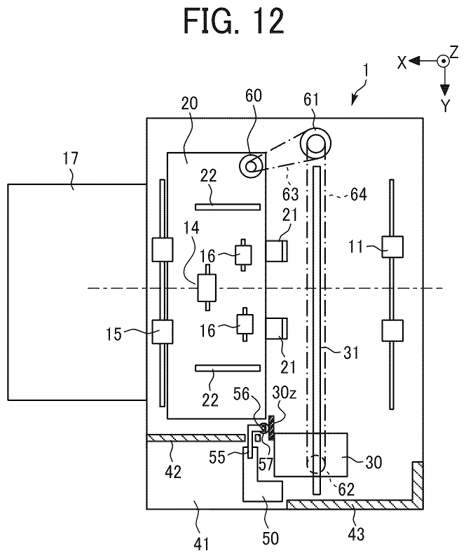

FIG. 12 is a top view of a post-processing apparatus according to Modification 2.

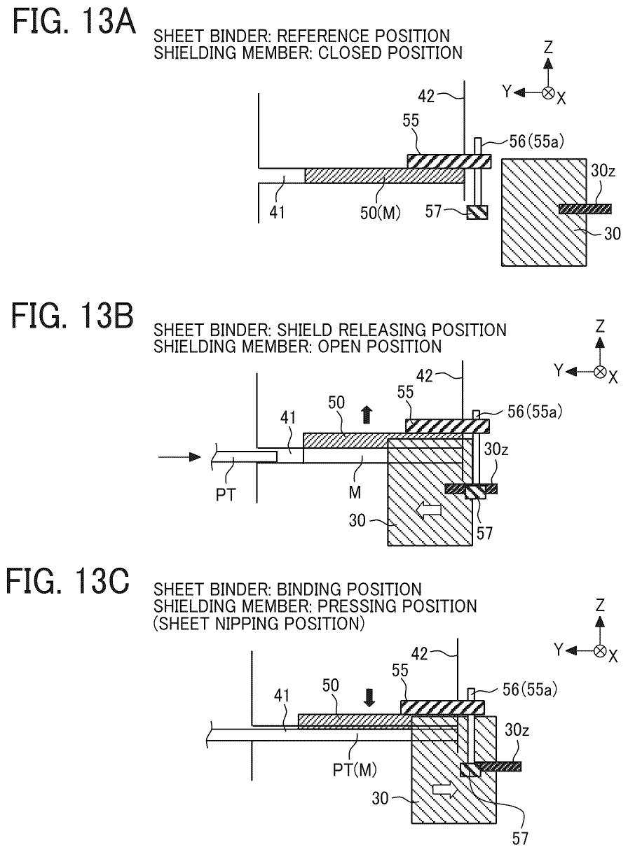

FIGS. 13A, 13B and 13C are diagrams illustrating operations of a shielding member and a sheet binder in a manual processing device of a post-processing apparatus.

As illustrated in FIGS. 12, 13A, 13B and 13C, the post-processing apparatus 1 according to Modification 2 includes an opening and closing mechanism of the shielding member 50 for opening and closing the opening M, which is different from the opening and closing mechanism of the shielding member 50 included in the post-processing apparatus 1 described above with reference to FIGS. 4A to 7C.

As illustrated in FIGS. 12, 13A, 13B and 13C, the shielding member 50 includes a holding portion 55, a ball screw 56, and a pinion gear 57, and the sheet binder 30 includes a rack gear 30z.

The holding portion 55 is disposed on top of the shielding member 50 as a single unit, and includes an internal thread 55a that penetrates the holding portion 55 in the vertical direction.

The pinion gear 57 is attached to the lower end of the ball screw 56 as a single unit. The ball screw 56 is screwed together with the internal thread 55a of the holding portion 55 (the shielding member 50), so as to be rotatable with the pinion gear 57. The ball screw 56 is restricted and held by a restrictor so that the position in the vertical direction (the ±Z direction) is not displaced.

The sheet binder 30 includes the rack gear 30z that can be screwed together with the pinion gear 57 of the shielding member 50.

Then, as illustrated in FIGS. 13A and 13B, the pinion gear 57 that is screwed together with the rack gear 30z of the sheet binder 30 rotates with the ball screw 56 along with the operation in which the sheet binder 30 moves to the shield releasing position illustrated in FIG. 13B, so that the shielding member 50 moves upward from the closed position illustrated in FIG. 13A to the open position illustrated in FIG. 13B.

The first guide wall 42 that partitions the manual processing device 41 and the interior of the post-processing apparatus 1 functions as a restrictor that restricts the rotation of the shielding member 50 (the holding portion 55). In other words, when the ball screw 56 moves in the ±Y direction and rotates with the rack gear 30z (the sheet binder 30) being meshed with the pinion gear 57, the first guide wall 42 as a restrictor contacts the shielding member 50 to prevent the shielding member 50 (the holding portion 55) from rotating with the ball screw 56. For this reason, as the ball screw 56 rotates, the shielding member 50 (the holding portion 55) moves in the vertical direction.

Further, as illustrated in FIGS. 13A, 13B and 13C, the meshing position at which the pinion gear 57 and the rack gear 30z mesh with each other changes along with the operation in which the movement mechanism (i.e., the stapler drive motor 60, the first pulley 61, the first timing belt 63, and the second timing belt 64) causes the sheet binder 30 to move to the reference position, the shield releasing position or the binding position, and the shielding member 50 moves to the closed position, the open position, or the pressing position. Then, the same operations of the sheet binder 30 and the shielding member 50 as the operations of the sheet binder 30 and the shielding member 50 described above with reference to FIGS. 6A to 8 are performed, except that the sheet binder 30 and the shielding member 50 have different opening and closing mechanisms of the opening M.

In the post-processing apparatus 1 according to Modification 2, the sound leakage from the opening M of the manual processing device 41 can be reduced without increase in size and cost of the post-processing apparatus 1.

### Modification 3

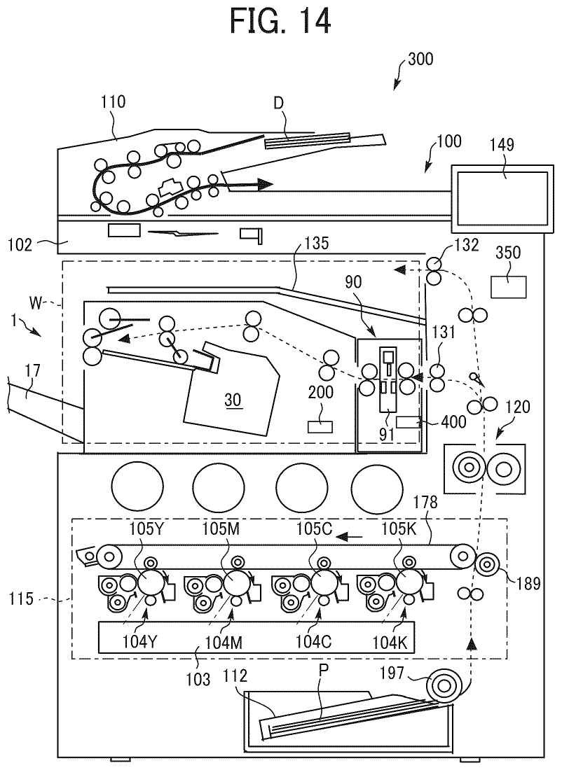

FIG. 14 is a diagram illustrating an overall configuration of an image forming system according to Modification 3.

As illustrated in FIG. 14, the image forming system 300 according to Modification 3 includes a hole puncher 90 as a second post-processing apparatus (optional apparatus). The hole puncher 90 is installed in the in-body space W of the image forming apparatus 100 and is disposed upstream (the upstream side in the sheet conveyance direction) from the post-processing apparatus 1 (first post-processing apparatus).

The hole puncher 90 includes a punch unit 91 therein. When a punching mode is selected by the user, the hole puncher 90 performs a punching operation on the sheet P that is inserted from the image forming apparatus 100.

Regardless of whether the punching operation is performed or not, the hole puncher 90 is to convey the sheet P ejected from the image forming apparatus 100, toward the post-processing apparatus 1.

Further, also in Modification 3, the post-processing apparatus 1 has the same configuration as the configuration described with reference to, for example, FIGS. 2 to 9 (or Modifications 1 and 2).

In the image forming system 300 having the configuration described above, the post-processing apparatus 1 can reduce sound leakage from the opening M of the manual processing device 41 without increasing in size and cost.

In Modification 3, the hole puncher 90 is installed as a second post-processing apparatus capable of executing the punching operation, but any device capable of executing another operation may be process may be installed as a second post-processing apparatus.

In Modification 3, the hole puncher 90 as the second post-processing apparatus is disposed upstream from the post-processing apparatus 1 as the first post-processing apparatus in the sheet conveyance direction. However, the hole puncher 90 as the second post-processing apparatus may be disposed downstream from the post-processing apparatus 1 as the first post-processing apparatus in the sheet conveyance direction.

As described above, the post-processing apparatus 1 according to the present embodiment includes the manual processing device 41 that communicates with the interior of the post-processing apparatus 1 via the opening M. A sheet bundle PT of multiple sheets P is inserted to the manual processing device 41. The post-processing apparatus 1 further includes the sheet binder 30 that performs the sheet binding operation on the sheet bundle PT inserted in the manual processing device 41 at the binding position of the opening M, and the shielding member 50 that moves from the closed position at which the opening M is closed to the open position at which the shielding of the opening M is released. The post-processing apparatus 1 further includes the movement mechanisms (i.e., the stapler drive motor 60, the first pulley 61, the first timing belt 63, and the second timing belt 64) (moving device) that moves the sheet binder 30.

Accordingly, the sound leakage from the opening M of the manual processing device 41 can be reduced without increasing in size and cost of the post-processing apparatus 1.

The image forming apparatus 100 and the image forming system 300 according to an embodiment of the present disclosure employs a color image forming apparatus but the configuration of the image forming apparatus and the image forming system are not limited to the above-described configurations. For example, a monochrome image forming apparatus and a monochrome image forming system are also applicable to achieve the effect of the present disclosure. In the present embodiment, the image forming apparatus 100 is an electrophotographic image forming apparatus and the image forming system 300 includes the image forming apparatus 100 as an electrophotographic image forming apparatus. However, the embodiments of the present disclosure are not limited to the electrophotographic image forming apparatus. In some embodiment, for example, the image forming apparatus may be an image forming apparatus of another system (for example, an image forming apparatus of an inkjet system or a stencil printer).

Further, in the present embodiment, the post-processing apparatus 1 coupled to the image forming apparatus 100 is applicable to the present disclosure. However, a standalone post-processing apparatus that is not coupled to an image forming apparatus may be also applicable to the present disclosure.

Further, in the present embodiment, the sheet binder 30 can be shared by the automatic processing device 39 and the manual processing device 41 but the configuration of the sheet binder is not limited to the above-described configuration. For example, a dedicated sheet binder may be installed in each of the automatic processing device 39 and the manual processing device.

In the present embodiment, when the sheet binder 30 is located at the shield releasing position, the shielding member 50 is located at open position. Further, when the sheet binder 30 is located at the binding position, the shielding member 50 is located at the pressing position to perform on the sheet bundle PT. In contrast, when the sheet binder 30 is located at the shield releasing position, the shielding member 50 may be located at the open position, so that the sheet binding operation may be performed on the sheet bundle PT without moving the shielding member 50 to the pressing position. In other words, the shield releasing position of the sheet binder 30 may be the binding position.

Any of the cases described above exhibits substantially the same advantages as the advantages of the present embodiment.

The present disclosure is not limited to the above-described embodiment and variations, and the configuration of the present embodiment can be appropriately modified other than suggested in the above embodiment and variations within a scope of the technological concept of the present disclosure. Further, features of components of the embodiments, such as the number, the position, and the shape are not limited to the embodiments and thus may be preferably set to be applied to the present disclosure.

The present disclosure may be applicable to, for example, a combination of the following Aspects 1 to 10.

### Aspect 1

In Aspect 1, a post-processing apparatus includes a manual processing device, a sheet binder, a shielding member, and a moving device. The manual processing device communicates with an interior of the post-processing apparatus via an opening. A sheet bundle including multiple sheets is inserted to the manual processing device. The sheet binder performs a sheet binding operation on the sheet bundle inserted in the manual processing device at a binding position of the opening. The shielding member moves from a closed position at which the opening is closed to an open position at which the shielding of the opening is released along with an operation in which the sheet binder moves to a shield releasing position. The moving device moves the sheet binder.

### Aspect 2

In Aspect 2, in the post-processing apparatus according to Aspect 1, the shielding member moves from the open position to the closed position along with an operation in which the moving device causes the sheet binder to move from the shield releasing position to a position other than the shield releasing position.

### Aspect 3

In Aspect 3, in the post-processing apparatus according to Aspect 1 or 2, the shielding member moves from the open position to a position at which the sheet bundle that is manually inserted and placed in the manual processing device is nipped, along with an operation in which the moving device causes the sheet binder to move from the shield releasing position to the binding position.

### Aspect 4

In Aspect 4, the post-processing apparatus according to any one of Aspects 1 to 3 further includes a guide and a biasing member. The guide guides the shielding member to be movable in the vertical direction between the closed position and the open position. The biasing member biases the shielding member downward toward the closed position. As the shielding member is moved by a moving portion of the sheet binder, the shielding member moves upward toward the open position against the biasing of the biasing member, along with an operation in which the sheet binder moves to the shield releasing position.

### Aspect 5

In Aspect 5, the post-processing apparatus according to any one of Aspects 1 to 3 further includes a ball screw and a restrictor. The ball screw is screwed with an internal thread of the shielding member and is rotatable with a pinion gear. The restrictor restricts a rotation of the shielding member. The sheet binder includes a rack gear that can be screwed with the pinion gear. The pinion gear that is screwed with the rack gear of the sheet binder rotates with the ball screw and the shielding member moves upward from the closed position to the open position, along with an operation in which the sheet binder moves to the shield releasing position.

### Aspect 6

In Aspect 6, in the post-processing apparatus according to any one of Aspects 1 to 5, the moving device causes the sheet binder to move from the binding position to the shield releasing position after the sheet binder has finished the sheet binding operation on the sheet bundle at the binding position.

### Aspect 7

In Aspect 7, in the post-processing apparatus according to any one of Aspects 1 to 6, when the sheet binder is located at the shield releasing position, as a start button is pressed, a controller controls the sheet binder to perform the sheet binding operation on the sheet bundle. When the start button is not pressed even after a given time has elapsed from the previous sheet binding operation or the shielding member moving to the open position from the closed position, the moving device causes the sheet binder to move from the binding position to a reference position in the interior of the post-processing apparatus.

### Aspect 8

In Aspect 8, in the post-processing apparatus according to any one of Aspects 1 to 6, when the sheet binder is at the shield releasing position, a detector detects that a sheet bundle is inserted to the sheet binding position to control the sheet binder to perform a sheet binding operation on the sheet bundle. Then, when the detector does not detect the sheet bundle even after a given time has elapsed from the previous sheet binding operation or from the shielding member has moved from the closed position to the open position, the sheet binder is moved by the moving device from the sheet binding position to a reference position in the post-processing apparatus.

### Aspect 9

In Aspect 9, an image forming system includes an image forming apparatus to form an image on a sheet, and the post-processing apparatus according to any one of Aspects 1 to 8.

### Aspect 10

In Aspect 10, in the image forming system according to Aspect 9, the image forming apparatus has an in-body space to which the sheet with the image is ejected and from which the sheet ejected from the image forming apparatus is removed. The post-processing apparatus is disposed in the in-body space of the image forming apparatus.

### Aspect 11

In Aspect 11, a post-processing apparatus includes a manual processing device, a sheet binder, a driver, and a shield. The manual processing device has an opening to receive a sheet bundle of multiple sheets inserted into the opening. The sheet binder performs a binding operation on the sheet bundle in the manual processing device at a binding position in the opening. The driver moves the sheet binder in a first direction. The shield is movable, in a second direction intersecting the first direction, between a closed position at which the shield closes the opening and an open position at which the shield opens the opening, in response to a movement of the sheet binder in the first direction.

### Aspect 12

In Aspect 12, in the post-processing apparatus according to Aspect 1, the driver moves the sheet binder, in the first direction, between a home position at which the shield is at the closed position, a releasing position at which the shield is at the open position, and a binding position, between the home position and the releasing position, at which the shield is at a pressing position to press the sheet bundle, and the sheet binder performs the binding operation and the shield moves from the open position toward the pressing position in response to the movement of the sheet binder from the releasing position toward the binding position.

### Aspect 13

In Aspect 13, in the post-processing apparatus according to Aspect 1 or 2, the shield moves from the open position to the pressing position in response to a movement of the sheet binder from the releasing position to the binding position.

### Aspect 14

In Aspect 14, the post-processing apparatus according to any one of Aspects 11 to 13 further includes a guide, a biasing member, and a pressed part. The guide guides the shield vertically movable between the closed position and the open position. The biasing member biases the shield downward toward the closed position. The pressed part is contactable with the sheet binder and moved by the sheet binder. The shield moves upward from the closed position to the open position against a biasing of the biasing member in response to a movement of the sheet binder from the home position toward the releasing position.

### Aspect 15

In Aspect 15, the post-processing apparatus according to any one of Aspects 1 to 13 further includes a pinion gear, a ball screw, and a restrictor. The ball screw is screwed with the shield and rotatable with the pinion gear. The restrictor restricts a rotation of the shield. The sheet binder includes a rack gear screwable with the pinion gear. The driver moves the sheet binder from the home position to the releasing position to screw the rack gear of the sheet binder with the pinion gear to move the shield upward from the closed position to the open position.

### Aspect 16

In Aspect 16, the post-processing apparatus according to any one of Aspects 11 to 15 further includes circuitry to control the driver to move the sheet binder from the binding position to the releasing position after the sheet binder has finished the binding operation on the sheet bundle at the binding position.

### Aspect 17

In Aspect 17, the post-processing apparatus according to any one of Aspects 11 to 16 further includes a start button, and circuitry. The start button is pressed to start the binding operation. The circuitry is to control the sheet binder to perform the binding operation on the sheet bundle when the sheet binder is at the releasing position and the start button is pressed, and control the driver to move the sheet binder from the binding position to the home position when the start button is not pressed even after a given time has elapsed from a previous binding operation or a movement of the shield from the closed position to the open position.

### Aspect 18

In Aspect 18, the post-processing apparatus according to any one of Aspects 11 to 16 further includes a detector and circuitry. The detector detects the sheet inserted into the binding position. The circuitry is to control the sheet binder to perform the binding operation on the sheet bundle as the detector detects the sheet bundle at the binding position when the sheet binder is at the releasing position, and control the driver to move the sheet binder from the binding position to a reference position in the post-processing apparatus when the detector does not detect the sheet bundle even after a given time has elapsed from a previous binding operation or from the shield has moved from the closed position to the open position.

### Aspect 19

In Aspect 19, an image forming system includes an image forming apparatus to form an image on a sheet of a sheet bundle, and the post-processing apparatus according to Aspects 11 to 18 to perform the binding operation on the sheet bundle inserted in the manual processing device.

### Aspect 20

In Aspect 20, in the image forming system according to Aspect 9, the image forming apparatus has an in-body space to which the sheet with the image is ejected, and from which the sheet ejected from the image forming apparatus is removable. The post-processing apparatus is disposed in the in-body space of the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A post-processing apparatus comprising:
a manual processing device having an opening to receive a sheet bundle of multiple sheets inserted into the opening;
a sheet binder to perform a binding operation on the sheet bundle in the manual processing device at a binding position in the opening;
a driver to move the sheet binder in a first direction; and
a shield movable, in a second direction intersecting the first direction, between:
a closed position at which the shield closes the opening; and
an open position at which the shield opens the opening,
in response to a movement of the sheet binder in the first direction.

2. The post-processing apparatus according to claim 1,
wherein the driver moves the sheet binder, in the first direction, between:
a home position at which the shield is at the closed position;
a releasing position at which the shield is at the open position; and
a binding position, between the home position and the releasing position, at which the shield is at a pressing position to press the sheet bundle, and the sheet binder performs the binding operation; and
the shield moves from the open position toward the pressing position in response to the movement of the sheet binder from the releasing position toward the binding position.

3. The post-processing apparatus according to claim 2,
wherein the shield moves from the open position to the pressing position in response to a movement of the sheet binder from the releasing position to the binding position.

4. The post-processing apparatus according to claim 2, further comprising:
a guide to guide the shield vertically movable between the closed position and the open position;
a biasing member to bias the shield downward toward the closed position; and
a pressed part contactable with the sheet binder and moved by the sheet binder,
wherein the shield moves upward from the closed position to the open position against a biasing of the biasing member in response to a movement of the sheet binder from the home position toward the releasing position.

5. The post-processing apparatus according to claim 2, further comprising:
a pinion gear;
a ball screw screwed with the shield and rotatable with the pinion gear; and
a restrictor to restrict a rotation of the shield,
wherein the sheet binder includes a rack gear screwable with the pinion gear, and the driver moves the sheet binder from the home position to the releasing position to screw the rack gear of the sheet binder with the pinion gear to move the shield upward from the closed position to the open position.

6. The post-processing apparatus according to claim 2, further comprising:
circuitry configured to control the driver to move the sheet binder from the binding position to the releasing position after the sheet binder has finished the binding operation on the sheet bundle at the binding position.

7. The post-processing apparatus according to claim 2, further comprising:
a start button to start the binding operation; and
circuitry configured to:
control the sheet binder to perform the binding operation on the sheet bundle when the sheet binder is at the releasing position and the start button is pressed; and
control the driver to move the sheet binder from the binding position to the home position when the start button is not pressed even after a given time has elapsed from:
a previous binding operation, or
a movement of the shield from the closed position to the open position.

8. The post-processing apparatus according to claim 2, further comprising:
a detector to detect the sheet inserted into the binding position; and
circuitry configured to:
control the sheet binder to perform the binding operation on the sheet bundle as the detector detects the sheet bundle at the binding position when the sheet binder is at the releasing position; and
control the driver to move the sheet binder from the binding position to a reference position in the post-processing apparatus when the detector does not detect the sheet bundle even after a given time has elapsed from a previous binding operation or from the shield has moved from the closed position to the open position.

9. An image forming system comprising:
an image forming apparatus to form an image on a sheet of a sheet bundle; and
the post-processing apparatus according to claim 1 to perform the binding operation on the sheet bundle inserted in the manual processing device.

10. The image forming system according to claim 9,
wherein the image forming apparatus has an in-body space:
to which the sheet with the image is ejected; and
from which the sheet ejected from the image forming apparatus is removable, and
the post-processing apparatus is disposed in the in-body space of the image forming apparatus.
